(19) United States
(12) Patent Application Publication
(10) Pub. No.: US 2017/0060906 A1
(43) Pub. Date: Mar. 2, 2017

(54) FLEXIBLE HYBRID ACCESS CONTROL

(71) Applicant: GOVERNMENT OF THE UNITED STATES AS REPRESETNED BY THE SECRETARY OF THE AIR FORCE, Rome, NY (US)

(72) Inventor: FRANK H. BORN, WESTERNVILLE, NY (US)

(21) Appl. No.: 14/843,089

(22) Filed: Sep. 2, 2015

(51) Int. Cl. G06F 17/30

(52) U.S. Cl. CPC G06F 17/30289; G06F 17/30477

(57) ABSTRACT

A system and computer software product for providing flexible control of access to information system data, files and other resources is presented. The invention employs a three cornered data arrangement that provides both fine grained access control and the simplicity of coarser grained access control systems. In addition the invention benefits from optional hierarchical inheritance along an unlimited number of hierarchies. Users can be assigned access to a resource in multiple ways. Access can be granted on a resource by resource basis or alternately to a group of resources. Access can also be inherited through three different channels. In addition these permission assignments can specify the extent of the control that the user will have over the resources that they are granted access to. Inheritance of access permissions through these hierarchies is an optional control that can be set within the invention.

### STATEMENT OF GOVERNMENT INTEREST

The invention described herein may be manufactured and used by or for the Government for governmental purposes.

### BACKGROUND OF THE INVENTION

Methods for granting or restricting access to digital resources are defined as the field to of access control. Access control is, or should be, the central function upon which other functions in a software system are built. Lack of adequate access control often results in users being able to see sensitive data that they should not have access to. The best example of this is Edward Snowden. The systems that he pilfered data from should have locked down his permissions such that he only had access to the items he had a valid need for.

Current access control methods are predominantly defined by either Role Based Access Control (RBAC) or by Access Control Lists (ACL). Mandatory Access Control (MAC) and Discretionary Access Control (DAC) are also important but are considered to be subsets of both of the above. Access Control Lists have an advantage over Role Based Access Control in that ACL provides better granularity of access control. The disadvantage of Access Control Lists is that they are much more cumbersome to establish and maintain in a large system. Role Based Access Control becomes increasingly more important as the size of the information system grows. This is because RBAC allows for granting access to multiple resources at a time by defining the user's role in the organization.

### OBJECTS AND SUMMARY OF THE INVENTION

This invention serves two critical system functions: 1) Control user access to create, read, update or delete resources contained in that system; 2) Facilitate the location of resources of interest o the user. The access control in this invention helps provide fine grained permission management while requiring a minimum number of manual permission assignments. The hierarchical tagging (taxonomies) provide context to the tags and facilitate data location and retrieval.

Other access control methods upon which this invention is built include Hierarchical Access Control and Tag Based Access Control. Hierarchical Access Control utilizes the parent child relationship to grant access based on the inheritance defined in this relationship. Tag Based Access Control allows the granting of permissions according to the tags that are identified for both a resource and a user.

This invention combines aspects of all of these access control methods and introduces additional novel and non-obvious control features that provide an extremely flexible access control method. This method not only greatly facilitates the granting and management of permissions to access resources but it also enables rapid resource location within a large data system.

The method of the present invention is based on a three cornered—three axis data arrangement with optional hierarchical inheritance in each axis. By using this method users can be assigned access to a resource in multiple ways. Access can be granted on a resource by resource basis or alternately to a group of resources. In addition each of these permission assignments can specify the extent of the control that user will have over the resources they are granted access to. Each axis of the access control system can contain hierarchical data contained in one or more hierarchical trees. Inheritance of access permissions through these hierarchies is optional. The three corners of the data arrangement represent distinct data categories that are termed here as 1) “Users”: This represents any entity that expresses ownership or requires access to a resource, 2) “Items”: These can represent any type of resource from physical assets to data items, 3) “Tags”: This contains both individual tags or one or more hierarchical arrangements of tags (taxonomy) used for categorizing the items (resources).

Additional options for this access control invention include 1) hierarchical inheritance that can be turned off or on for each corner of the data arrangement, 2) role assignments for both individual resource access and access to groups of resources, 3) multiple distinct item tables allowing coverage of distinct data sources, 4) minimized data arrangement allowing easy overlay of the access control invention on existing information systems.

In a relational database the data described would be represented in tables. Each of these tables could benefit from hierarchical relationships between items in that table. For example, in a business, users will generally have a boss who can be thought of as their “parent” or “ancestor”. Similarly, tags can often be combined in a hierarchical arrangement or taxonomy. Items can also have a “parent”. For example consider that the resource is a machine piece part. That piece part may be part of a hierarchical arrangement including a system, subsystem, assembly, module etc.

Inheritance of access through a hierarchy allows for quick access assignments to groups of resources. IE Bosses can inherit access permissions from their employees, personnel assigned access to certain machine assembly would inherit access to the subassemblies and piece parts that the assembly consists of Inheritance also can be applied to the taxonomy of tags. Consider a resource that is identified (tagged) as belonging to a certain department. The department might belong to a certain agency. Users who have been granted access to the agency could inherit access to the resources in all the departments of that agency.

Hierarchical permissioning can be turned on or off for users, tags and/or items. For example, a hierarchy in the user data would identify the employee management chain. If hierarchical access control is enabled for that tree structure then each boss would inherit the permissions that their employees have been granted. A similar situation exists for the items and tags data tables. If hierarchical access control is enabled for a hierarchy in the items table (i.e. machinery items), then the user who has been granted access to the top level of the machinery hierarchy would also have access to the assemblies, sub-assemblies, components and piece parts identified in that hierarchy.

The flexibility inherent in this arrangement is manifold. The following is a description of the ways in which a user can be granted access to an item. Note that while these access control scenarios are all possible with this invention they are likely to be tailored based on the needs of the system operator and only selectively applied. The following is an enumeration of the possible methods of granting access. As noted before, access can be granted one resource at a time or to a group of resources. Granting of access to a group of resources (items) can be done my tagging those resources with a certain tag and then associating the user with that tag. The user can also receive access to the group of resources that are “owned” by the user's subordinates, or to the group of resources that are subordinate to a resource that the user has access to. Lastly, the user can receive access to the group of resources that are linked to a tag that is subordinate to another tag that the user has access to. As a practical example of these methods here is a description of the situations that would grant a user access to a specific item. 1) User X can be given direct access to Item Y via a link between the user and the item; 2) User X could have access to item Y if User X is linked to a tag that Item Y is linked to; 3) User X could have access to Item Y if User X's subordinates are linked to Item Y; 4) User X could have access to Item Y if User X is linked to a parent (ancestor) item in the hierarchy that contains Item Y; 5) User X could have access to item Y if User X is linked to a tag that is a parent (ancestor) to a tag that item Y is linked to.

The overwhelming advantage of this invention is the simplicity with which these complicated access control decisions can be made. The method for evaluating an access request is a simple two-st p process shown in a figure in this invention and explained in the “Detailed Description . . . ” section of the application.

It is therefore an object of the present invention to control access to information system resources using a three cornered data arrangement consisting of users, taxonomy, and resources with links relating each to the other two.

It is another object of the present invention to manage access using both fine grained and coarse rained controls.

It is another object of the present invention to provide access control to diverse resource types in one system.

It is yet another object of the present invention to provide multiple methods for granting a user access to the same resources.

It is still another object of the present invention to allow optional hierarchical inheritance separately on each of three major data nodes.

It is still another object of the present invention to combine methods of Role Based Access Control, Access Control Lists, Tag based Access Control and Hierarchical Access Control in a flexible hybrid access control mechanism.

It is still yet another object of the present invention to enable pick information system resource location.

It is still yet another object of the present invention to provide method for overlay of this access control mechanism on an existing information system.

In an embodiment of the present invention, a system for providing access control to machine-based information, comprises a machine and a set of machine implementable instructions stored on a non-transitory machine-readable storage media, wherein the instructions cause the machine to assign unique identifiers to users, to machine-based information items, and to item tags; identify association links between users, items, and item tags; identify hierarchical relationships among users, among items, and among tags; and when any user in a user hierarchy is linked to any item, permit any user access to any item according to one or more predetermined roles; and when any user in a user hierarchy is linked to any tag in a tag hierarchy wherein any tag is linked to any item, permit any user access to any item according to one or more predetermined roles.

Still, according to an embodiment of the present invention, a system for providing access control to machine-based information, when any user in a user hierarchy is not linked to any item, and when said any user in a user hierarchy is not linked to any tag in a tag hierarchy wherein any tag is linked to any item, denying said any user access to any item according to one or more predetermined roles.

Briefly stated, the present invention provides an apparatus and computer software product for flexible hybrid access control to information system data, files and other resources. The invention is based on a three cornered data arrangement that provides both fine grained access control and the simplicity of coarser grained access control systems. In addition this access control system benefits from optional hierarchical inheritance along an unlimited number of hierarchies. The invention proves to be extremely flexible in that by using this method users can be assigned access to a resource in multiple ways. Access can be granted on a resource by resource basis or alternately to a group of resources. Access can also be inherited through three different channels. In addition these permission assignments can to specify the extent of the control that the user will have over the resources that they are granted access to. Each corner of the data arrangement in this access control system can contain hierarchical data arranged in one or more hierarchical trees. Inheritance of access permissions through these hierarchies is an optional control that can be set on the invention. The three corners of the data arrangement represent distinct data categories for 1) “Users”: This represents any entity that expresses ownership or requires access to a resource, 2) “Items”: These can represent any type of resource from physical assets to data items, 3) “Tags”: This contains both individual tags or one or more hierarchical arrangements of tags (taxonomy) used for categorizing the items (resources).

Additional options for this access control invention include 1) hierarchical inheritance that can be turned off or on for each corner of the data arrangement, 2) role assignments for both individual resource access and access to groups of resources, 3) multiple distinct item tables allowing coverage of distinct data sources, 4) minimized data arrangement allowing easy overlay of the access control invention on existing information systems.

### BRIEF DESCRIPTION OF THE DRAWINGS

FIG. 1 depicts the relationship and linking between data sources for users, tags and items in the access control system.

FIG. 2 shows hypothetical hierarchical arrangement of users, tags and items data in the access control system. This hypothetical arrangement of data shows that the data can be arranged hierarchically in one or more tree structures in each of these tables. It also shows that it is not required for all data in these tables to be part of a hierarchy.

FIG. 3 shows the schema and example data for the table containing User data.

FIG. 4 shows the schema and example data for the table containing Item data.

FIG. 5 shows the schema and example data for the table containing Tag data.

FIG. 6 shows the schema and example data for the links between Users and Items.

FIG. 7 shows the schema and example data for the links between Users and Tags.

FIG. 8 shows the schema and example data for the links between Tags and Items.

FIG. 9 is a flow chart that describes the query process required to determine the level of access a user is allowed for a particular item.

FIG. 10 depicts the relationship between data sources in the access control system when multiple resource types (items) are being managed by the system.

### DETAILED DESCRIPTION OF THE PREFERRED EMBODIMENT

The present invention presents a method for controlling access to data and other resources controlled by a computer system. In particular this invention presents a method for providing multiple methods for granting users of the software system access to resources on a one by one basis or a category by category basis. This access can be further defined by details of what the user is allowed to do with the resource (i.e. “Read Only”) or, the access can also be defined by a more complicated rule set as identified for a specific “Role” that the user is granted. Additionally this invention allows for access to be granted indirectly via hierarchical inheritance within three distinct data types. The hierarchy of users would usually be the employee—management chain, the hierarchy of tags would be one or several “Taxonomies”, lastly the hierarchy of items (resources) could be something such as would be seen in data concerning machinery, i.e. System-Subsystem-Assembly-Component-Piece part hierarchy.

In relational databases the invention describes a three cornered data relationship using data tables holding user data (Users)tags/taxonomy data (Tags) and item/resource data (Items). Between these three tables are three linking tables that connect each of the three to the other two tables. These simple data connections allow an integration of multiple existing access control methods into a hybrid system that enables extreme flexibility in defining data access assignments. It also allows both “fine grained” and “course grained” access assignments—thus enabling system operators to specify any level of data access without being overburdened.

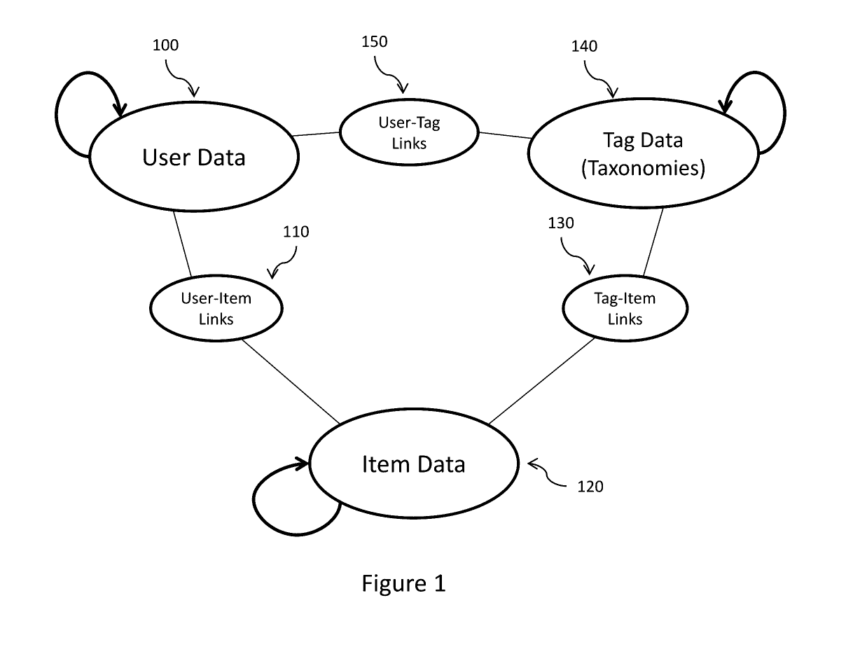

Referring to FIG. 1, this illustration depicts the relationship and linking between data sources for users, tags and items in the access control system of the present invention. Note that these data sources will normally be held in tables as in a relational data base but could be held in other formats. Data containing user parameters such as name, address etc. is identified as User Data 100. The user data will also typically be assigned a unique identifier that is assigned to each user. It can optionally include a method for referencing another user in this data collection. Allowing a user record to reference another user record is usually done by including a “parent ID” that points to the unique identifier for another user. This parent-child relationship will organize the data into one or more hierarchical tree structures. The top most user in a tree structure is the user with no parent identified. Data containing item parameters such as name, location, etc. is shown in FIG. 1 as Item Data 120. As is the case with User Data, each item in Item Data will typically be assigned a unique identifier and to may (optionally) allow one item to reference another via a parent ID or similar. Data containing tagging (category) parameters is identified as Tag Data 140. As is the case with User Data and Item Data, each tag in Tag Data will typically have a unique identifier assigned to it by the invention and may (optionally) allow one tag to reference another via a parent ID or similar. In the case of Tag data the tree structures that result from self-referencing are considered to be Taxonomies rather than just a group of tags.

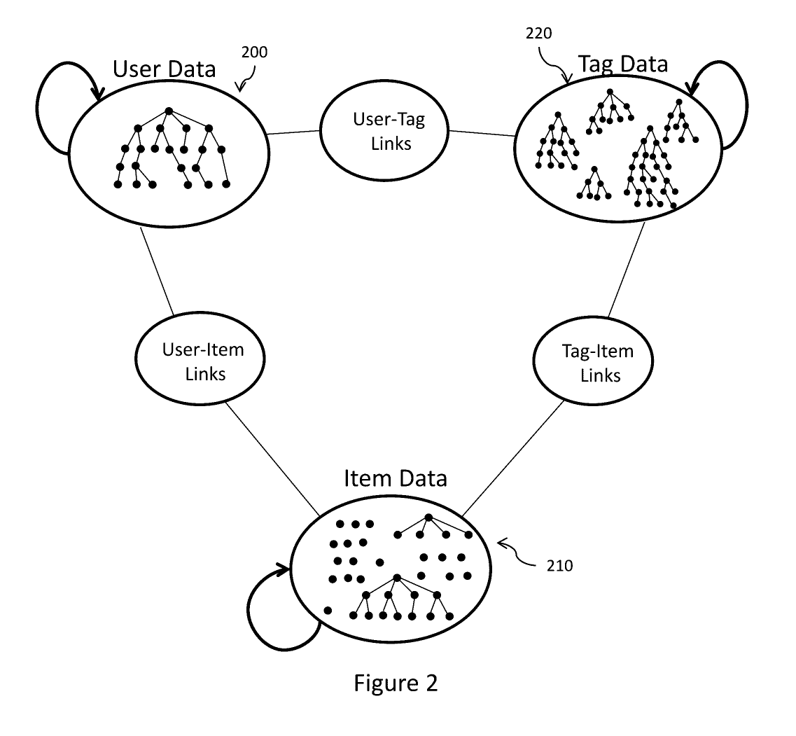

Referring to FIG. 2 a sample hierarchical tree structure is shown in the User Data table 200. Although only one hierarchy is shown this table would support multiple hierarchies. An example of a user hierarchy is the employee management chain in a company. This could include one or more tree structures such as the employee-management chain in a company. Note that it is not necessary for each user identified in this data to have a boss or employee as is shown in this figure. The Item Data 210 shows example data that is grouped into two tree structures and with multiple unassociated items. The example Tag Data 220 shown in this figure is grouped in five separate tree structures (taxonomies). All three of these tables 200, 210, 220 can support multiple hierarchies and/or data not associated with any hierarchy.

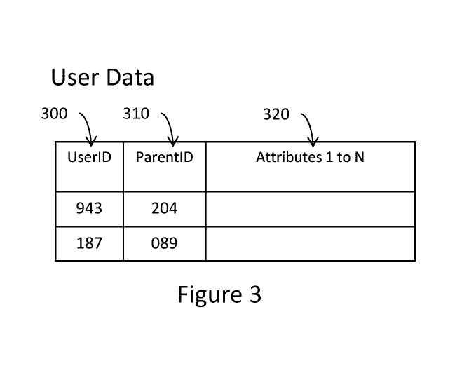

Referring to FIG. 3, this table shows a suggested schema for the User data. In most cases each user will be assigned a unique identifier by the system. We call this the “UserID” 300 for this example. Optionally the system can allow one user to reference another user as their boss or manager. This can be done by identifying this other user's unique id in a column we call “ParentID” 310. A value of null in the ParentID field indicates that this user is at the top of a hierarchy or is not associated with a hierarchy. Multiple users may have a null ParentID indicating that there may be more than one management hierarchies represented in this data. Additional data about the user (i.e. their name, address etc.) can be stored in this table in the “Attribute” column 320. If this access control system is implemented as an overlay on an existing data system then the attributes identified as element 320 would likely be in tables in the existing data system. In this case the UserID field 300 would be a pointer to a row of user data in the existing system.

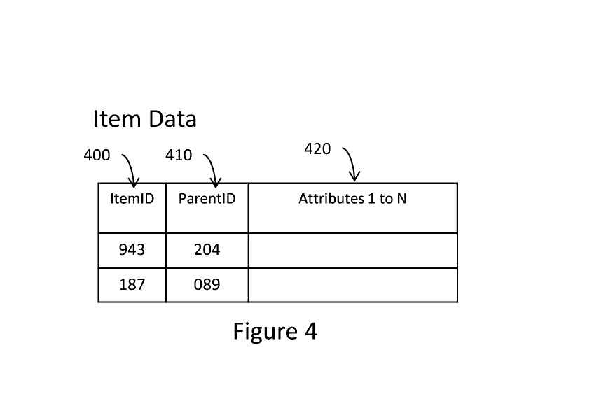

Is Referring to FIG. 4, this table shows a suggested schema for the Item data. In most cases each item will be assigned a unique identifier by the system. For this example we call this identifier the “ItemID” 400. Optionally the system can allow one item to reference another item that it is subordinate to. This can be done by identifying this other item's unique id in a column we call “ParentID” 410. A value of null in the ParentID field indicates that this item is not subordinate to any other item. Additional data about the item (i.e. their name, purpose, location etc.) can be stored in this table in the “Attribute” columns 420. If this access control system is implemented as an overlay on an existing data system then the attributes identified as element 420 would likely be in tables in the existing data system. In this case the ItemID field 400 would be a pointer to a row of item data in the existing system.

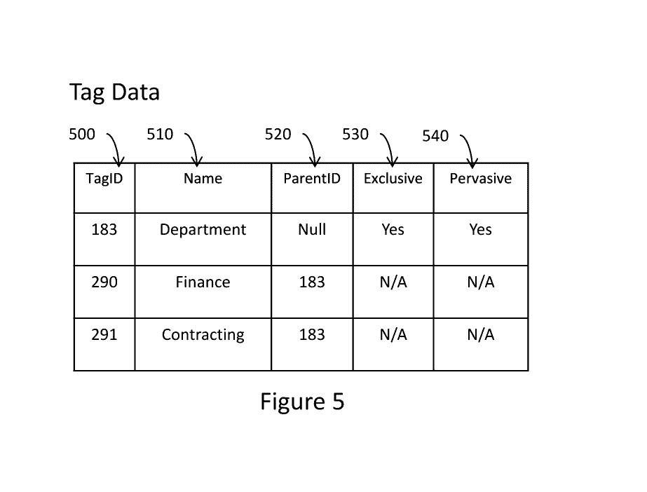

Referring to FIG. 5, this table shows a suggested schema for the Tag data. In most cases each tag will be assigned a unique identifier by the system. For this example we call this identifier the “TagID” 500. Optionally the system can allow one tag to reference another tag that it is subordinate to. This can be done by identifying this other tag's identification id in a column we call “ParentID” 510. When tags are arranged hierarchically they form taxonomies, such as would be used to identify species of plants. Tags with a null ParentID are either at the top of the hierarchy or they are not associated with any of the other tags. The attributes shown in FIG. 5 “Exclusive” 530, and “Pervasive” 540 are additional controls that can be added to the system to aid in access control. These are granted on a hierarchy by hierarchy basis. Since tags with a null ParentID are at the top of their respective hierarchy these top most tags will be used to specify the behavior of the whole tree beneath them. Thus, the controls for Exclusive and Pervasive will only be assigned for tags with a null ParentID. The Exclusive field 530 will be used to identify if more than one tag from this hierarchy can be assigned to a specific item. Using the example data shown in FIG. 5, the “Exclusive” designation for the “Department” tree means that each item in the item table can only be linked to one tag in the Department tree. The “Pervasive” field 540 will be used to designate the Department tree whether all items (in the item table) must be linked to one (or more) tags in the Department tree. Using the example data shown in FIG. 5, the “Pervasive” designation for the “Department” tree means that each item in the item table must be linked to one (or more) tags in the Department tree. If this access control system is implemented as an overlay on an existing data system no changes should be required in the description of this table.

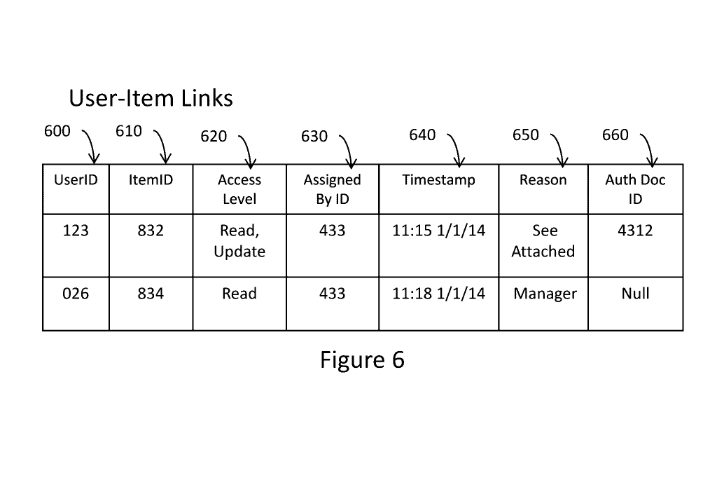

Referring to FIG. 6, this table shows example data in the preferred schema containing the links between users and items. Given that both the users and items were assigned a unique identifier (“UserID” 600, “ItemID” 610 respectively) these identifiers can be linked together in a manner as shown in this figure. This linking will result in some level of access to the identified item being granted to the identified user. Another parameter that can be identified for this User-Item link is the level of access this user is allowed for this item (“Access Level” 620). Traditional user access levels follow the CRUD acronym. This stands for “Create”, “Read”, “Update”, and “Delete”. These parameters can be used in the Access Level field or other application specific parameters can be used in the Access Level field such as would be used in a traditional role based access control system. Other fields that can be included in this linking table include the UserID of the person who made the link (“Assigned by ID” 630), the time at which this link was created (“Timestamp” 640), the reason why this link was made (“Reason” 650) and a pointer to a document that supports or authorizes this link (“Auth Doc ID” 660). If this invention is used as an overlay to an existing data system no changes to this table would be necessary.

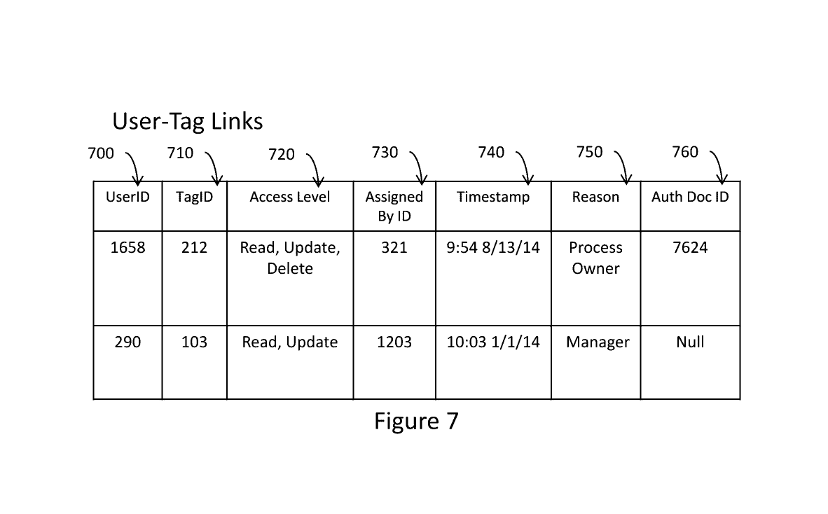

Referring to FIG. 7, this table shows example data in the preferred schema containing the links between users and tags. Given that both the users and tags were assigned a unique identifier (“UserID” 700, “TagID” 710 respectively) these identifiers can be linked together in a manner as shown in this figure. This linking will often result in some level of access being granted to the identified user to all items associated with the identified tag. Other parameters that can be identified are the level of access this user is allowed for this item (“Access Level” 720), the UserID of the person who made the link (“Assigned by ID” 730), the time at which this link was created (“Timestamp” 740), the reason why this link was made (“Reason” 750) and a pointer to any document uploaded to the system that supports or authorizes this link (“Auth Doc ID” 760). If this invention is used as an overlay to an existing data system no changes to this table would be necessary.

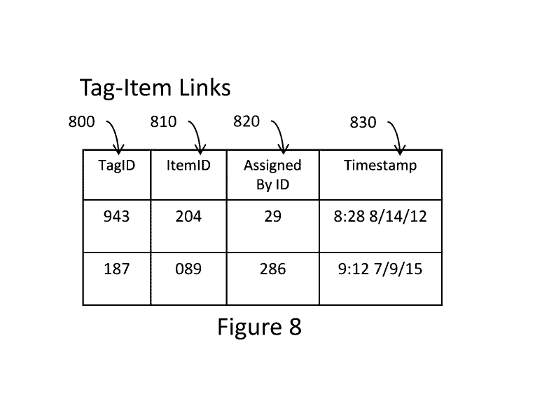

Referring to FIG. 8, this table shows example data in the preferred schema containing the links between tags and items. Given that both the tags and items were assigned a unique identifier (“TagID” 800, “ItemID” 810 respectively)these identifiers can be linked together in a manner as shown in this figure. Other parameters that can be identified are UserID of the person who made the link (“Assigned by ID” 820), the time at which this link was created (“Timestamp” 830). In contrast to the other linking tables (FIG. 6 and FIG. 7), there is no need for an “Access Level”, “Reason” or “Auth Doc ID” field in this linking table because users are not identified in these links nor is user access to items being directly granted. If this invention is used as an overlay to an existing data system no changes to this table would be necessary.

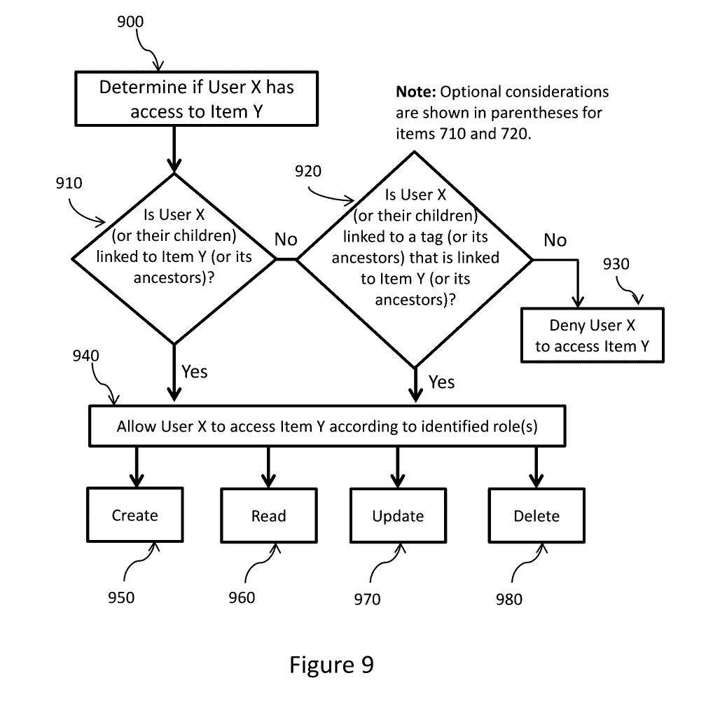

Referring to FIG. 9, this flow chart shows the decision making process to determine what, if any, access a user is given to a specific item. The method to determine if User X has access to Item Y is as follows 900. In the simplest case there will be no inherited access from other users or items in the hierarchy (user hierarchy and item hierarch, respectively). In this case we first determine if User X is linked (i.e., associated with) directly to Item Y 910. If the answer to this is yes then allow User X access to the Item Y according to the “Access Level” identified in the User-Item link table 940. This access could be further defined by any of the following Create 950, Read 960, Update 970, Delete 980. Other access levels besides these could also be defined here. In the case where hierarchical inheritance (i.e., hierarchical relationships) is allowed, the query must determine the following: “Is User X, or their children, linked to Item Y or its ancestors?” 910. An answer of Yes for this will grant User X access to item Y 940. If the answer is “No” to the query identified in 910 then this next question is asked (for the case without inherited access): “Is User X linked to a tag that is linked to Item Y” 920? If the answer is “Yes” then access for that user to that item is granted 940. In the case where access can be inherited the following query is used: “Is User X (or their children, i.e., user hierarchy) linked to a tag (or its ancestors, i.e., tag hierarachy) that is linked to Item Y (or its ancestors, i.e., item hierarchy)?” 920. If the answer is “Yes” then the user is granted access to that item 940. In either case if the answer is “No” to the query identified in 910 then User X will not be granted permission to Item Y 930. Note that different permutations of the queries identified in 910 and 920 exist when only 1 or 2 of the three data tables allow hierarchical inheritance. The queries identified in the flow chart of FIG. 9 could easily be used to precompute the user's access periodically, such as when the user logs into the system. This would create a simplified, temporary table that would identify every item that User X has access to. This would allow for rapid access control determinations.

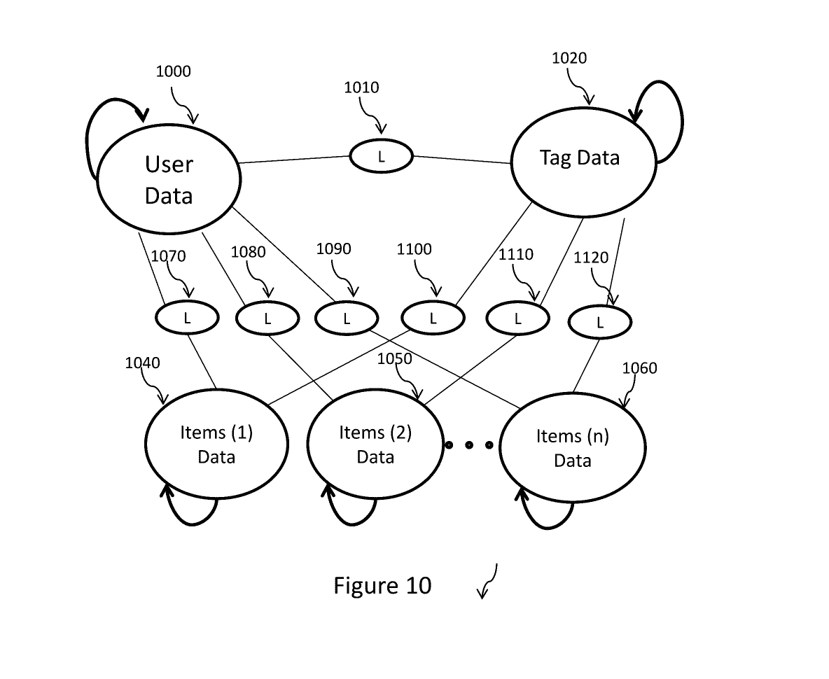

Referring to FIG. 10, this illustration depicts the data relationship when multiple distinct item tables are necessary in a system. For example, in a manufacturing company the first item table might represent “Machinery”, the second table might represent “Projects” and another item table might represent “Accounts”. Since these categories are dissimilar the attributes that describe them will also be dissimilar. For that reason it is necessary that they have their own “Items” table with the appropriate attributes list identified. In this illustration User Data 1000 is still directly linked 1010 to the Tag Data 1020. User Data must also be directly linked to each of the Items tables 1040, 1050, 1060 through the linking tables 1070, 1080, 1090. Similarly the Tag Data must also be directly linked to each of the Items tables 1040, 1050, 1060 through the linking tables 1100, 1110, 1120. As noted above each of these items tables will have a different set of attributes to describe the items they contain.

What is claimed is:

1. A system for providing access control to machine-based information, comprising:
a machine; and
set of machine implementable instructions stored on a non-transitory machine-readable storage media, wherein said instructions cause said machine to:
assign unique identifiers to users, to machine-based information items, and to item tags;
identify association links between said users, items, and item tags;
identify hierarchical relationships among said users, among said items, and among said tags;
when any user in a user hierarchy is linked to any item, permit said any user access to said any item according to one or more predetermined roles; and
when any user in a user hierarchy is linked to any tag in a tag hierarchy wherein said any tag is linked to any item, permit said any user access to said any item according to one or more predetermined roles.

2. The system of claim 1, wherein said one or more predetermined roles are selected from the group consisting of creating, reading, updating, and deleting said any item.

3. The system of claim 1, wherein
when any user in a user hierarchy is not linked to any item, and
when said any user in a user hierarchy is not linked to any tag in a tag hierarchy wherein said any tag is linked to any item, denying said any user access to said any item according to one or more predetermined roles.

4. The system of claim 1, wherein said machine is a computer.

5. The system of claim 1, wherein said unique identifiers further comprise numerical identifiers.

6. The system of claim 1, wherein said association links between said users and said items and said users and said tags further comprise at least one attribute.

7. The system of claim 6, wherein said at least one attribute is selected from the group consisting of Access Level, Assigned by ID, Timestamp, Reason, Authorization Document ID.

8. The system of claim 1, wherein said tags include attributes selected from the group consisting of Exclusive and Pervasive.

9. The system of claim 8 wherein said attribute Exclusive, when attached to a top most tag in a tag hierarchy, denotes that only one said tag from said tag hierarchy can be assigned to a particular item.

10. The system of claim 8 wherein said attribute Pervasive, when attached to a top most tag in a tag hierarchy, denotes that each item must be linked to at least one tag from said tag hierarchy.

11. The system of claim 1, wherein access can be inherited from a subordinate in any said hierarchical relationship to which any said user, said tag, or said item belongs.

12. The system of claim 11, wherein said inherited access from a subordinate in any said hierarchical relationship can be individually enabled or disabled for any said user, said tag, or said item.

13. A computer software product embodied in a non-transitory computer-readable storage media for providing access control to computer-based information, wherein said computer software product, when executed by said computer, causes said computer to:
assign unique identifiers to users to machine-based information items, and to item tags;
identify association links between said users, items, and item tags;
identify hierarchical relationships among said users, among said items, and among said tags;
when any user in a user hierarchy is linked to any item, permit said any user access to said any item according to one or more predetermined roles; and
when any user in a user hierarchy is linked to any tag in a tag hierarchy wherein said any tag is linked to any item, permit said any user access to said any item according to one or more predetermined roles.

14. The computer software product of claim 13, wherein said one or more predetermined roles are selected from the group consisting of creating, reading, updating, and deleting said any item.

15. The computer software product of claim 13, wherein
when any user in a user hierarchy is not linked to any item, and
when said any user in a user hierarchy is not linked to any tag in a tag hierarchy wherein said any tag is linked to any item, denying said any user access to said any item according to one or more predetermined roles.

16. The computer software product of claim 13, wherein said unique identifiers further comprise numerical identifiers.

17. The computer software product of claim 13, wherein said association links between said users and said items and said users said tags further comprise at least one attribute.

18. The computer software product of claim 17, wherein said at least one attribute is selected from the group consisting of Access Level, Assigned by ID, Timestamp, Reason, Authorization Document ID.

19. The system of claim 13, wherein said tags include attributes selected from the group consisting of Exclusive and Pervasive.

20. The computer software product of claim 19, wherein said attribute Exclusive, when attached to a top most tag in a tag hierarchy, denotes that only one said tag from said tag hierarchy can be assigned to a particular item.

21. The computer software product of claim 19, wherein said attribute Pervasive, when attached to a top most tag in a tag hierarchy, denotes that each item must be linked to at least one tag from said tag hierarchy.

22. The computer software product of claim 13, wherein access can be inherited from a subordinate in any said hierarchical relationship to which any said user, said tag, or said item belongs.

23. The computer software product of claim 22, wherein said inherited access from a subordinate in any said hierarchical relationship can be individually enabled or disabled for any said user, said tag, or said item.
